(19) United States
(12) Patent Application Publication
(10) Pub. No.: US 2016/0244677 A1
(43) Pub. Date: Aug. 25, 2016

(54) APPARATUSES AND METHODS FOR FLUID CATALYTIC CRACKING WITH FEEDSTOCK TEMPERATURE CONTROL

(71) Applicant: UOP LLC, Des Plaines, IL (US)

(72) Inventor: Derek Froehle, Wheeling, IL (US)

(21) Appl. No.: 14/629,778

(22) Filed: Feb. 24, 2015

(51) Int. Cl. C10G 11/00; B01J 8/18

(52) U.S. Cl. CPC C10G 11/00; B01J 8/1809; B01J 8/1836; B01J 2208/00044; B01J 2208/00256; B01J 2208/00902

(57) ABSTRACT

Apparatuses and methods are provided for fluid catalytic cracking. A fluid catalytic cracking apparatus includes a riser with a first inlet. A first distributor pipe is coupled to the riser at the riser inlet. A heat transfer device is coupled to the first distributor pipe, where the heat transfer device includes a coolant outlet exterior to the riser, and wherein the heat transfer device is a counter current heat transfer device.

### TECHNICAL FIELD

The present disclosure generally relates to apparatuses and methods used in fluid catalytic cracking, and more particularly relates to apparatuses and methods for controlling feedstock temperatures for fluid catalytic cracking units.

### BACKGROUND

It is desirable to produce fuels and other useful materials from renewable resources, such as natural oils. Natural organic matter, such as wood, agricultural waste, algae, and a wide variety of other feedstocks can be heated in the absence of oxygen to produce pyrolysis oil. The pyrolysis oil is produced from biomass in a pyrolysis reactor, so the pyrolysis oil is a renewable resource and a natural oil. Pyrolysis oil can be directly used as a fuel for some applications, such as certain boilers and furnaces, and it can also serve as a feedstock for the production of fuels in petroleum refineries. Pyrolysis oil has the potential to replace petroleum as the source of a significant portion of transportation fuels. However, pyrolysis oil is a complex, highly oxygenated organic liquid having properties that currently limit its utilization as a biofuel. For example, pyrolysis oil has high acidity and a low energy density attributable in large part to oxygenated hydrocarbons. These oxygenated hydrocarbons can undergo secondary reactions during storage or when heated to produce undesirable compounds, such as oligomers, polymers, and other compounds that cause plugging and block liquid transport operations. However, many pyrolysis oils become viscous if they become too cold, so the pyrolysis oils should be transported and stored within certain temperature ranges.

Fluid catalytic cracking (FCC) is primarily used to convert high boiling, high molecular weight hydrocarbons from petroleum into lower boiling, lower molecular weight compounds. The lower molecular weight compounds include gasoline, olefinic compounds, liquid petroleum gas (LPG), diesel fuel, kerosene, etc., where the feedstock and the operating conditions can be adjusted to shift yields to a desired product. During FCC unit operations, hydrocarbons are cracked with a cracking catalyst in a riser in the FCC unit, coke deposits on the cracking catalyst in the riser, and the coke is burned off in a regenerator to regenerate the cracking catalyst. The cracking catalyst is repeatedly cycled through the riser and regenerator while cracking hydrocarbons. Pyrolysis oil or other natural oils can be processed in FCC units to increase its value and utility for use as a fuel or as a raw material for other processes. However, the riser of the FCC unit is hot, so the pyrolysis oil may polymerize and “plug” when introduced to the riser. Pyrolysis oil is one example of a natural oil that can be processed in an FCC unit, but other natural oils or feedstocks that have temperature limitations can also be processed.

Accordingly, it is desirable to develop methods and apparatuses for introducing natural oils or other feedstocks to FCC units without plugging. In addition, it is desirable to develop methods and apparatuses for controlling the temperature of the feedstocks as they are introduced to the FCC unit. Furthermore, other desirable features and characteristics of the present embodiment will become apparent from the subsequent detailed description and the appended claims, taken in conjunction with the accompanying drawing and this background.

### BRIEF SUMMARY

Apparatuses and methods are provided for fluid catalytic cracking. In an exemplary embodiment, a fluid catalytic cracking apparatus includes a riser with a first inlet. A first distributor pipe is coupled to the riser at the riser inlet. A heat transfer device is coupled to the first distributor pipe, where the heat transfer device includes a coolant outlet exterior to the riser, and wherein the heat transfer device is a counter current heat transfer device.

In another embodiment, a fluid catalytic cracking apparatus includes a riser with a first inlet. A first distributor pipe is coupled to the riser at the first inlet. A temperature control device is coupled to the first distributor pipe, where the temperature control device is configured to control a feedstock injection temperature.

A method of catalytically cracking hydrocarbons is also provided. The method includes fluidizing a cracking catalyst in a riser at cracking conditions, and injecting a first feedstock into the riser through a first distributor pipe at a feedstock injection temperature. The feedstock injection temperature is controlled to within a prescribed temperature range with a coolant, where the coolant flows through a temperature control device coupled to the first distributor pipe. The coolant exits the temperature control device exterior to the riser. The coolant flows through the heat transfer device in a counter current manner.

### BRIEF DESCRIPTION OF THE DRAWINGS

Various embodiments will hereinafter be described in conjunction with the following drawing figures, wherein like numerals denote like elements, and wherein.

FIG. 1 is a cross-sectional view of a fluid catalytic cracking apparatus in accordance with exemplary embodiments;

FIG. 2 is a schematic diagram of a portion of a fluid catalytic cracking apparatus in accordance with exemplary embodiments; and

FIGS. 3-5 are side sectional views of various embodiments of a heat transfer device for a first distributor pipe of a fluid catalytic cracking apparatus.

### DETAILED DESCRIPTION

The following detailed description is merely exemplary in nature and is not intended to limit the application or uses of the embodiment described. Furthermore, there is no intention to be bound by any theory presented in the preceding technical field, background, brief summary, or the following detailed description.

Fluid catalytic cracking (FCC) apparatuses and methods for fluid catalytic cracking of hydrocarbons are provided. In accordance with various embodiments, a first feedstock is introduced into a riser of the FCC apparatus, and contacted with a cracking catalyst at cracking conditions. The first feedstock is added to the riser through a first distributor pipe, where the first feedstock is maintained within a prescribed temperature range until it is introduced into the riser. The hot riser tends to heat the first feedstock within the first distributor pipe, so a temperature control device is coupled to the first distributor pipe to control the temperature of the feedstock and prevent overheating. By “control”, as referred to herein, it is meant that the temperature of the feedstock is actively modified to maintain the temperature of the feedstock within a predetermined range. A coolant is used in the temperature control device, and the coolant is not introduced to the riser so the riser operations are not impacted by the additional coolant.

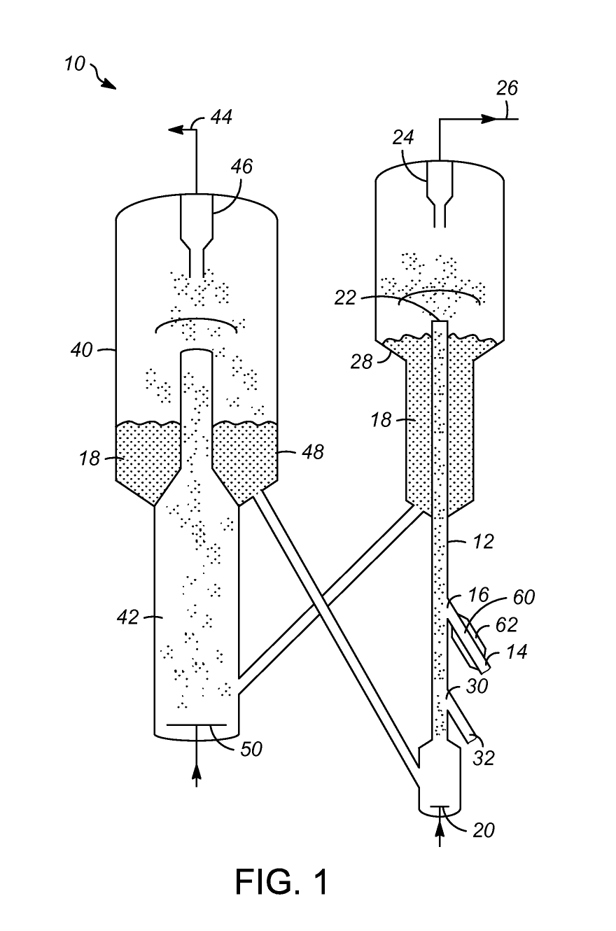

In accordance with an exemplary embodiment and referring to FIG. 1, an FCC apparatus 10 includes a riser 12 and a regenerator 40. A first feedstock 14 is introduced to the riser 12 for cracking at a first inlet 16, where the first feedstock 14 is a feedstock for the riser 12. The first inlet 16 is defined in the riser 12, such as an opening in a wall of the riser 12. The first feedstock 14 includes a pyrolysis oil in an exemplary embodiment, but the first feedstock 14 may alternatively include a different natural oil, a petroleum oil, a chemical by-product, other materials, or a combination of materials. The first feedstock 14 may include about 20 weight percent to about 100 weight percent natural oil in an exemplary embodiment, or about 50 to about 100 weight percent natural oil, or about 80 to about 100 weight percent natural oil in alternate embodiments. The natural oil in the first feedstock 14 may be about 90 to about 100 weight percent pyrolysis oil in an exemplary embodiment, but other types of natural oil may be used in alternate embodiments.

Pyrolysis oil is produced by thermally decomposing organic matter in the absence of oxygen. In some embodiments, the pyrolysis oil is produced by rapid thermal pyrolysis, where the organic matter is rapidly heated to a reaction temperature of about 400° C. to about 900° C., maintained at the reaction temperature for about 0.5 to 2 seconds, and the vapors formed are then rapidly cooled to quench the pyrolysis reaction. However, other types of pyrolysis can be used in alternate embodiments.

Many pyrolysis oils are maintained within a pyrolysis oil flow temperature range for flowability reasons. Heavy organic or non-organic components in the pyrolysis oil tend to produce a high viscosity if the temperature falls below a pyrolysis oil flow temperature range (referred to herein as a “gelling temperature”). For example, the oil may solidify or “gel” if the oil temperature falls too low, but the oil will flow again if its temperature is raised to within the pyrolysis oil flow temperature range. Oxygenated organic compounds, olefins, aromatics, or other compounds in the pyrolysis oil tend to polymerize if the temperature rises above the pyrolysis oil flow temperature range. Therefore, if the temperature is too high, the oil polymerizes and forms a solid or gel that will not flow, even if the temperature is subsequently lowered to within the pyrolysis oil flow temperature range. In some cases, pyrolysis oil will polymerize and gel rapidly if heated above the pyrolysis oil flow temperature range, (referred to herein as a “polymerization temperature”) so plugging can occur when the oil is heated for short periods of time, such as about 5 minutes, 1 minute, 30 seconds, or 10 seconds in various embodiments. Furthermore, pyrolysis oil may begin to polymerize such that a pipe or conduit is gradually plugged as the oil flows through it. The pyrolysis oil flow temperature range is from about 30 degrees centigrade (° C.) to about 130° C., or from about 50 to about 100° C., or from about 50 to about 90° C. in various embodiments. As such, the first feedstock may be controlled to within an oil flow temperature range, which generally is from about the gelling temperature to about the polymerization temperature. The pyrolysis oil flow temperature range may vary from one type of pyrolysis oil to another, or between pyrolysis oils formed from different raw materials. When the first feedstock 14 is pyrolysis oil, the pyrolysis oil flow temperature range may be the prescribed temperature range for the first feedstock 14. However, other prescribed temperature ranges may apply when the first feedstock 14 includes different materials.

Other natural oils also have natural oil flow temperature ranges. For example, a natural oil with a polymerizable functional group can polymerize if the temperature is raised too high, and many materials will solidify or plug if the temperature falls too low. Many natural oils include carbon-carbon double bonds on the fatty portion of the triglycerides, and these carbon-carbon double bonds may polymerize when the temperature exceeds a natural oil flow temperature range. For example, linoleic acid derived triglycerides, such as those found in sunflower oil, often include two carbon-carbon double bonds. Some natural oils or other materials may include conjugated carbon-carbon double bonds, where the double bonds are adjacent to each other, and these compounds may readily polymerize. For example, conjugated linoleic acid includes a conjugated double bonds, and pyrolysis oil includes compounds with conjugated double bonds as well. In embodiments with natural oil as the first feedstock 14, the natural oil flow temperature range may be the prescribed temperature range for the first feedstock 14. The prescribed temperature range is generally warm enough for the first feedstock 14 to be a flowable liquid, but cold enough to inhibit polymerization or other undesired chemical reactions.

The first feedstock 14 is contacted with a cracking catalyst 18 in the riser 12. The cracking catalyst 18 can be a wide variety of cracking catalysts 18 as is known in the art.

Suitable cracking catalysts 18 for use herein include high activity crystalline alumina silicate and/or zeolite, which may be dispersed in a porous inorganic carrier material such as silica, alumina, zirconia, or clay. An exemplary embodiment of a cracking catalyst 18 includes crystalline zeolite as the primary active component, a matrix, a binder, and a filler. The zeolite ranges from about 10 to about 50 mass percent of the catalyst, and is a silica and alumina tetrahedral with a lattice structure that limits the size range of hydrocarbon molecules that can enter the lattice. In an embodiment, the matrix component includes amorphous alumina, and the binder and filler provide physical strength and integrity. For example, in a specific embodiment, silica sol or alumina sol are used as the binder and kaolin clay is used as the filler. Different cracking catalysts 18 may be used in alternate embodiments.

The first inlet 16 is positioned at a low portion of the riser 12, so the first feedstock 14 travels upward through most of the length of the riser 12. For example, the first inlet 16 may be from about 0.1 meters to about 10 meters from the bottom of the riser 12, where the riser 12 may be about 5 to about 20 meters tall, but other dimensions are also possible. Hydrocarbons in the first feedstock 14 are vaporized, carried up through the riser 12 with the cracking catalyst 18, and reacted (cracked) primarily within the riser 12. The cracking catalyst 18 is fluidized in the riser 12 by a riser gas distributor 20, where the riser gas distributor 20 may include one or more of steam, light hydrocarbons, nitrogen, or other gases. The first feedstock 14 is typically introduced into the riser 12 as a liquid, and the hydrocarbons in the first feedstock 14 are vaporized by heat from the hot cracking catalyst 18. As the vaporized hydrocarbons and cracking catalyst 18 rise up through the riser 12, the hydrocarbons contact with the cracking catalyst 18 and are cracked into smaller hydrocarbons.

In an exemplary embodiment, the riser 12 operates at a cracking temperature of from about 450° C. to about 600° C. The cracking temperature is measured in the vaporous stream at or near an outlet 22 of the riser 12, where “near the outlet” is defined to mean within about 1 meter of the outlet 22. Operating pressures in the riser 12 may be from about 100 kilo Pascals gauge (kPa) to about 250 kPa. The operating conditions may vary depending on several factors, including but not limited to, the composition of the first feedstock 14, the cracking catalyst 18, residence time in the riser 12, catalyst loading in the riser 12, the desired product, etc. The riser 12 is generally designed for a given feedstock and production rate, so the size, flow rate, and proportions can vary widely. In an exemplary embodiment, the riser 12 is designed for a first feedstock 14 residence time of from about 0.5 to about 10 seconds, but other residence times are also possible.

The FCC apparatus 10 may optionally include a second inlet 30 defined in the riser, with a second feedstock 32 introduced to the riser 12 at the second inlet 30. The second inlet 30 may be positioned below the first inlet 16, where the use of two different inlets allows for the separate introduction of two different feedstocks into the riser 12. The second feedstock 32 may include a petroleum oil such as vacuum gas oil (VGO), hydrotreated VGO, atmospheric distillation column bottoms, demetallized oil, deasphalted oil, hydrocracker main column bottoms, combinations of the above, or other petroleum oils. Other suitable components for the second feedstock 32 include Fischer-Tropsch liquids derived from renewable or non-renewable feedstocks, triglycerides of vegetable or animal origin, natural oils, and the like. In some embodiments, the second feedstock 32 has an initial boiling point of about 300 degrees centigrade (° C.) or higher (at atmospheric pressure), and is a material that can vaporize and flow. In many embodiments, the second feedstock 32 is a mixture of different compounds, so it has a boiling range instead of a single boiling point, where the boiling range begins at the initial boiling point described above. In some embodiments, the hydrocarbons have an average molecular weight of about 200 to about 600 Daltons or higher. The first feedstock 14 may be heated to a temperature of from about 150° C. to about 450° C. (300° F. to 850° F.) before entry into the riser 12.

The second inlet 30 may be below the first inlet 16, and may be about 0.5 to about 9 meters below the first inlet 16 on the riser 12. In alternate embodiments, the second inlet 30 is about 1 to about 8 meters below the first inlet 16, or about 4 to about 6 meters below the first inlet 16. In embodiments with the second inlet 30 below the first inlet 16, the second feedstock 32 contacts the cracking catalyst 18 for a longer period of time than the first feedstock 14. Also, the cracking reaction is endothermic, so the cracking catalyst 18 cools as the cracking catalyst 18 and the second feedstock 32 travel up the riser 12. As such, the second feedstock 32 initially contacts the cracking catalyst 18 at a higher temperature than when the first feedstock 14 initially contacts the cracking catalyst 18. The different positions of the first and second inlets 16, 30 allows for greater control of the cracking conditions for different feedstocks, so riser operations can be somewhat customized for different types of feedstock. In alternate embodiments, there is no second inlet 30, or there may be more than two inlets.

In an exemplary embodiment, the first feedstock 14, the second feedstock 32, (if present,) and the cracking catalyst 18 travel up the riser 12 to a riser catalyst separator 24 fluidly coupled to the riser 12. The vaporous hydrocarbons exit the riser catalyst separator 24 in a riser effluent 26 and the cracking catalyst 18 exits the riser catalyst separator 24 and collects in a riser catalyst collector 28. Coke is deposited on the cracking catalyst 18 in the riser 12 such that the cracking catalyst 18 is at least partially coated with coke when falling into the riser catalyst collector 28. The riser catalyst separator 24 may be one or more cyclones, impingement separators, other gas/solid separators, or combinations thereof. The cracking catalyst 18 is transferred to a regenerator 40 fluidly coupled to the riser catalyst collector 28, and the riser effluent 26 flows to a fractionation zone (not illustrated) for further processing.

In an exemplary embodiment, the cracking catalyst 18 from the riser catalyst collector 28 is transferred to the regenerator 40 to oxidize the coke deposits formed on the cracking catalyst 18 in the riser 12, which is often referred to as burning off the coke. Coke is burnt off the spent cracking catalyst 18 in a combustion zone 42 to produce a flue gas stream 44 and regenerated cracking catalyst 18. The cracking catalyst 18 is separated from the flue gas stream 44 in a regenerator catalyst separator 46, such as one or more cyclones, impingement separators, other gas/solid separators, or combinations thereof, and the cracking catalyst 18 is collected in a regenerator catalyst collector 48. An oxygen supply gas 50 is coupled to the combustion zone 42 and carries the fluidized cracking catalyst 18 through the combustion zone 42. The coke is burned off the cracking catalyst 18 by contact with the oxygen supply gas 50 at regeneration conditions. In an exemplary embodiment, air is used as the oxygen supply gas 50, because air is readily available and provides sufficient O₂ for combustion, but other gases with a sufficient concentration of O₂ could also be used, such as purified O₂. If air is used as the oxygen supply gas 50, about 10 to about 15 kilograms (kg) of air is required per kg of coke burned off of the cracking catalyst 18. Exemplary regeneration conditions include a temperature from about 500° C. to about 900° C. and a pressure of about 150 kPa to about 450 kPa. The superficial velocity of the oxygen supply gas 50 is typically less than about 2 meters per second, and the density within the combustion zone 42 is typically about 80 to about 400 kilograms per cubic meter. However, the regenerator 40 may be designed and sized based on the expected duty, so the regenerator 40 may be larger or smaller than as described above.

The hydrocarbon cracking reaction is endothermic, and heat is required to vaporize the hydrocarbons from the first feedstock 14 and the second feedstock 32, if present. In some embodiments, the heat is primarily supplied by the cracking catalyst 18 that is transferred from the regenerator 40 to the riser 12. As such, the FCC apparatus 10 may be about energy neutral, in that the energy used to vaporize and crack the hydrocarbons is primarily provided by the energy released from regenerating the cracking catalyst 18. In an exemplary embodiment, about 70 percent of the heat used in the riser 12 is used to vaporize the first feedstock 14 and the second feedstock 32 (if present) with about 30 percent used to drive the endothermic cracking reaction, depending on the operating conditions and the composition of the first and second feedstocks 14, 32. The combustion of coke is an exothermic reaction, so the cracking catalyst 18 is heated as it is regenerated. In an exemplary embodiment, the cracking catalyst 18 has a temperature of about 600° C. to about 760° C. when transferred from the regenerator 40 to the riser 12.

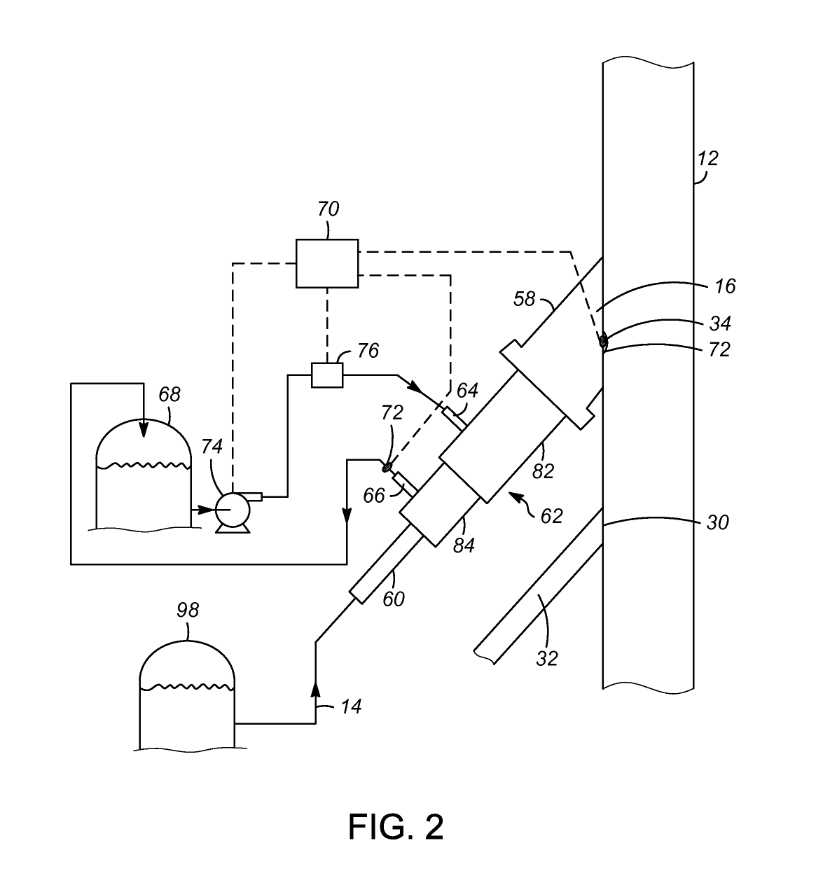

Reference is made to the exemplary embodiment in FIG. 2, with continuing reference to FIG. 1. The first feedstock 14 is maintained within the prescribed temperature range prior to injection into the riser 12, as mentioned above. The first feedstock 14 flows through a first distributor pipe 60 coupled to the riser 12 at the first inlet 16. The first distributor pipe 60 may be introduced into the riser 12 through a port 58, where the first distributor pipe 60 may be coupled to other pipes or conduits. The port 58 may be a blast nozzle or other port, and a packing gland or other seal may prevent leaks from the riser 12 through the port 58 when the first distributor pipe 60 (and any optional associated piping) is in place. The first feedstock 14 may be stored in a natural oil storage unit 98 fluidly coupled to the first distributor pipe 60. The natural oil storage unit 98 is configured to provide a natural oil to the first inlet 16 as the first feedstock 14, but other types of feedstocks are provided in alternate embodiments.

The riser 12 is vertical in many embodiments, and the first distributor pipe 60 may be coupled to the riser 12 at from about 30 degrees to about 60 degrees, such that the first distributor pipe 60 is angled upwards as it intersects the riser 12. The port 58 may have a similar or identical angel. This angle may facilitate injecting the first feedstock 14 upwards into the riser 12 to aid in the generally upward flow within the riser 12. The first distributor pipe 60 may also intersect the riser 12 at a right angle or at other angles in alternate embodiments. In an exemplary embodiment, a nozzle 34 is coupled to the end of the first distributor pipe 60 at the first inlet 16, where the nozzle 34 is configured to atomize a liquid, such as the first feedstock 14, and inject the atomized liquid into the riser 12. The nozzle 34 may produce a cone-shaped spray, a fan-shaped spray, a mist, etc., when injecting the first feedstock 14 into the riser 12. The nozzle 34 and/or the first distributor pipe 60 may be flush with the wall of the riser 12 so they do not extend into the flow path within the riser 12. The flow of cracking catalyst 18 within the riser 12 may be abrasive, so the lifespan of the nozzle 34 and first distributor pipe 60 may be extended if they are not within the flow path of the cracking catalyst 18.

The first feedstock 14 is injected into the riser 12 at a feedstock injection temperature. The first feedstock 14 remains liquid and flowable until it is atomized and injected into the riser 12 by the nozzle 34, so the feedstock injection temperature may be below the boiling point or range of the first feedstock 14. The riser 12 typically operates at high temperatures that may be well above the prescribed temperature range of the first feedstock 14, so the riser 12 may have a tendency to heat the first feedstock 14 to above the prescribed temperature range prior to injection of the first feedstock 14. The first distributor pipe 60 may be coupled to a heat transfer device 62 that can be used to control the temperature of the first feedstock 14 within the first distributor pipe 60. The heat transfer device 62 can be used to maintain the temperature of the first feedstock 14 within the prescribed temperature range until it is injected into the riser 12. The heat transfer device 62 may include a coolant inlet 64 and a coolant outlet 66 that are outside of the riser 12, so coolant can flow through the heat transfer device 62 to control the feedstock injection temperature, without the coolant being injected into the riser 12. The feedstock injection temperature may be controlled with a coolant that is injected into the riser 12, but the addition of the coolant into the riser 12 may adversely impact the operation of the riser 12 or increase the cost of operation. For example, coolant injected into the riser 12 may reduce the quantity of feedstock that can be added, the injected coolant is lost, and the injected coolant may need to be separated from the riser effluent 26. Therefore, a heat transfer device 62 with the coolant outlet 66 exterior to the riser 12 allows for recovery of the coolant and reduces dilution of the feedstock in the riser 12.

The coolant used in the heat transfer device 62 may be stored in a coolant storage unit 68, where the coolant storage unit 68 is configured to store the coolant in liquid form. The coolant storage unit 68 is fluidly coupled to the heat transfer device 62 such that coolant flows from the coolant storage unit 68 to the coolant inlet 64 of the heat transfer device 62, and coolant flows from the coolant outlet 66 of the heat transfer device 62 back to the coolant storage unit 68.

In some embodiments, a temperature control device 70 is used in conjunction with a first temperature sensing device 72 to control the feedstock injection temperature to within the prescribed temperature range. The first temperature sensing device 72 may be a thermocouple, a thermometer, or other device capable of measuring temperature. The first temperature sensing device 72 may be positioned within the first distributor pipe 60 to measure the temperature of the first feedstock 14 at or near the nozzle 34. As such, the first temperature sensing device 72 may be within about 5 centimeters of the wall of the riser 12, and within the first distributor pipe 60. However, in other embodiments, the first temperature sensing device 72 may be within the flow path of the coolant, or within the natural oil storage unit 98 (not illustrated), at other locations, or there may be a plurality of first temperature sensing devices 72 at several different locations. The temperature control device 70 may adjust the flow rate of coolant to the heat transfer device 62 based on the readings of the temperature sensing element. The flow rate of the coolant can determine how much the first feedstock 14 is cooled, so changes to the flow rate can change the feedstock injection temperature. For example, the flow from a variable coolant pump 74 can be reduced or increased to control the feedstock injection temperature. In other embodiments, a valve (not illustrated) can control the flow of coolant. In other embodiments, the temperature of the coolant can be controlled, such as with a coolant heat exchanger 76. Changes in the temperature of the coolant can also change the feedstock injection temperature, and can therefore be used for control purposes.

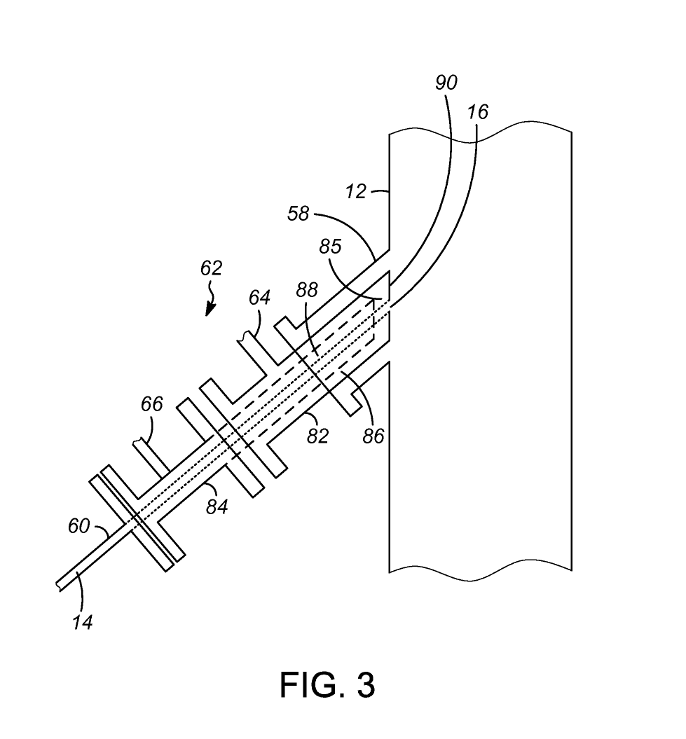

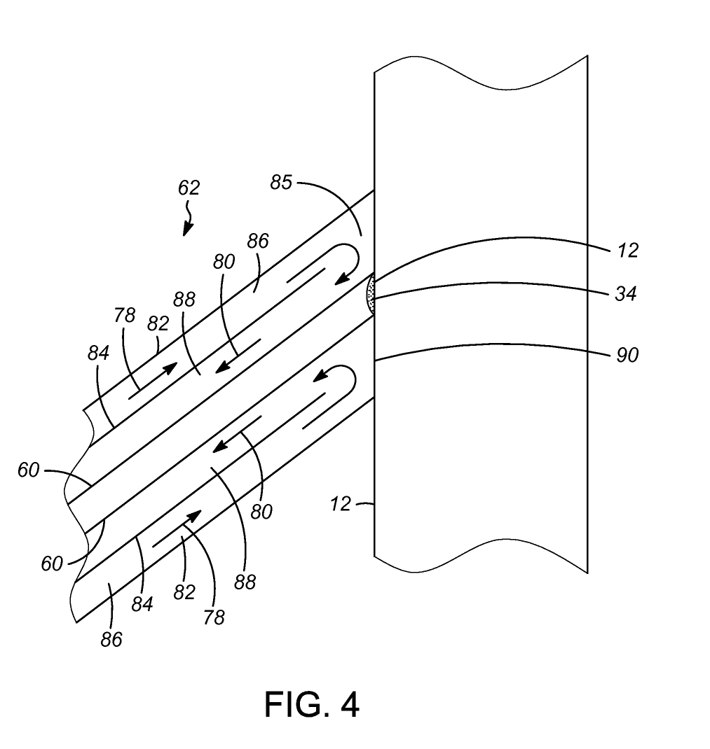

Many designs are available for the heat transfer device 62. For example, the heat transfer device 62 may be as illustrated in FIGS. 3 and 4, with continuing reference to FIG. 1. The heat transfer device 62 illustrated in FIGS. 3 and 4 includes an exterior sleeve 82 and an interior sleeve 84 with a counter current design, where the exterior sleeve 82 is inserted into the port 58. The term “counter current” as used herein indicates the direction of flow of coolant along one surface of a process pipe is opposite to the direction of flow of process fluid (such as the first feedstock 14) along the opposite side of the process pipe. The first distributor pipe 60 is positioned within the interior sleeve 84 to define an interior annular space 88 between the first distributor pipe 60 and the interior sleeve 84. The interior sleeve 84 is positioned within the exterior sleeve 82 to define an exterior annular space between the interior sleeve 84 and the exterior sleeve 82. The space between the exterior sleeve 82 and the port 58 may include a packing gland or sealing device to prevent fluid flow, or leaks. The heat transfer device 62 includes a face plate 90 coupled to the first distributor pipe 60 and the exterior sleeve 82, but the interior sleeve 84 is not directly coupled to the face plate 90. An interior gap 85 is defined between the face plate 90 and the interior sleeve 84, where coolant can flow through the interior gap 85. The face plate 90 may be flush with the riser 12, such as with a riser wall, to reduce abrasion from the cracking catalyst 18 flowing upward within the riser 12. As such, the illustrated heat transfer device 62 is a counter current heat transfer device 62.

In more general terms, the heat transfer device 62 includes a coolant inlet path 78 and a coolant outlet path 80 for coolant flow in and out of the heat transfer device 62, respectively. The coolant inlet path 78 extends from the coolant inlet 64 to the face plate 90, and the coolant outlet path 80 extends from the face plate 90 to the coolant outlet 66. As such, the coolant inlet path 78 may be the exterior annular space 86, and the coolant can change directions at the interior gap 85 so the coolant outlet path 80 is the interior annular space 88. The coolant inlet path 78 could be the interior annular space 88 and the coolant outlet path 80 could be the exterior annular space 86 in another embodiment.

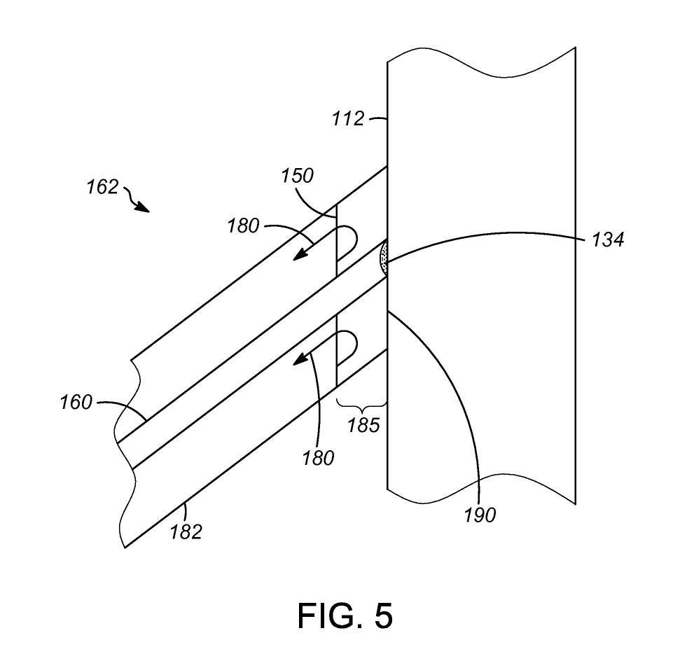

Another embodiment of the heat transfer device 162 is illustrated in FIG. 5, with continuing reference to FIG. 1. Components in FIG. 5 that are similar to previously described components include the number “1” before the two digits used above, so the components in FIG. 5 have different reference numbers for clarity but can be associated with similar components described above. New components in FIG. 5 also begin with the number 1, but do not include a two digit reference number used above. The heat transfer device 162 includes an exterior sleeve 182 around the first distributor pipe 160, where the exterior sleeve 182 and the first distributor pipe 160 are coupled to the face plate 190 that is flush with the riser 112. The nozzle 134 is at the end of the first distributor pipe 160. A baffle 158 is coupled to the exterior sleeve 182 and the first distributor pipe 160, but the baffle 158 stops short of the face plate 190 to define the interior gap 185 between the baffle 158 and the face plate 190. The coolant inlet path (not illustrate) is between the exterior sleeve 182 and the first distributor pipe 160 on one side of the baffle 158, the coolant flows through the interior gap 185 between the end of the baffle 158 and the face plate 190, and the coolant outlet path 180 is between the exterior sleeve 182 and the first distributor pipe 160 on the other side of the baffle 158. Other embodiments of the heat transfer device 162 are also possible, as understood by those skilled in the art. The use of the heat transfer device 162 as described above allows for control of the feedstock injection temperature without the addition of coolant into the riser 12. The controlled feedstock injection temperature may increase the number of raw materials that can be processed in an FCC apparatus 10 over FCC apparatuses without the heat transfer device 162.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the application in any way. Rather, the foregoing detailed description will provide those skilled in the art with a convenient road map for implementing one or more embodiments, it being understood that various changes may be made in the function and arrangement of elements described in an exemplary embodiment without departing from the scope, as set forth in the appended claims.

What is claimed is:

1. A fluid catalytic cracking apparatus comprising:
a riser, wherein the riser defines a first inlet;
a first distributor pipe coupled to the riser at the first inlet; and
a heat transfer device coupled to the first distributor pipe, wherein the heat transfer device comprises a coolant outlet exterior to the riser, and wherein the heat transfer device is a counter current heat transfer device.

2. The fluid catalytic cracking apparatus of claim 1 further comprising a nozzle coupled to the first distributor pipe, wherein the nozzle is configured to inject a fluid from the first distributor pipe into the riser.

3. The fluid catalytic cracking apparatus of claim 2 wherein the nozzle is configured to atomize the fluid from within the first distributor pipe and inject the fluid into the riser.

4. The fluid catalytic cracking apparatus of claim 1 further comprising a coolant inlet fluidly coupled to the heat transfer device, wherein the coolant inlet is exterior to the riser.

5. The fluid catalytic cracking apparatus of claim 1 wherein the riser defines a second inlet.

6. The fluid catalytic cracking apparatus of claim 5 wherein the first inlet is positioned higher on the riser than the second inlet.

7. The fluid catalytic cracking apparatus of claim 1 wherein the heat transfer device comprises an exterior sleeve and an interior sleeve, wherein the first distributor pipe is positioned within the interior sleeve and the interior sleeve is positioned within the exterior sleeve.

8. The fluid catalytic cracking apparatus of claim 7 wherein the heat transfer device comprises a face plate coupled to the first distributor pipe and the exterior sleeve such that an exterior annular space defined between the exterior sleeve and the interior sleeve is fluidly coupled to an interior annular space defined between the interior sleeve and the first distributor pipe through an interior gap defined between the interior sleeve and the face plate.

9. The fluid catalytic cracking apparatus of claim 1 wherein the heat transfer device comprises a face plate, a coolant inlet path extending from a coolant inlet to the face plate, and a coolant outlet path extending from the coolant outlet to the face plate.

10. The fluid catalytic cracking apparatus of claim 1 further comprising a natural oil storage unit, wherein the first distributor pipe is fluidly coupled to the natural oil storage unit.

11. The fluid catalytic cracking apparatus of claim 1 further comprising a temperature control device coupled to the heat transfer device, wherein the temperature control device is configured to control a feedstock injection temperature to within a prescribed temperature range.

12. The fluid catalytic cracking apparatus of claim 11 wherein the temperature control device is configured to control the feedstock injection temperature to from about a gelling temperature to about a polymerization temperature.

13. The fluid catalytic cracking apparatus of claim 1 further comprising a coolant storage unit, wherein the coolant storage unit is configured to store liquids.

14. The fluid catalytic cracking apparatus of claim 1 wherein the riser is vertical and wherein the first distributor pipe is coupled to the riser at an angle of from about 30 degrees to about 60 degrees such that the first distributor pipe is angled upward.

15. The fluid catalytic cracking apparatus of claim 1 further comprising a face plate coupled to the first distributor pipe, wherein the face plate is further coupled to the riser such that the face plate is flush with the riser.

16. A fluid catalytic cracking apparatus comprising:
a riser, wherein the riser defines a first inlet;
a first distributor pipe coupled to the riser at the first inlet; and
a temperature control device coupled to the first distributor pipe, wherein the temperature control device is configured to control a feedstock injection temperature.

17. The fluid catalytic cracking apparatus of claim 16 further comprising a first temperature sensing device coupled to the temperature control device, wherein the first temperature sensing device is configured to measure a temperature within the first distributor pipe within about 5 centimeters of the riser.

18. The fluid catalytic cracking apparatus of claim 17 further comprising a heat transfer device coupled to the first distributor pipe, wherein the heat transfer device comprises a coolant outlet exterior to the riser, and wherein the temperature control device is configured to adjust a coolant flow within the heat transfer device based on measurements from the first temperature sensing device.

19. The fluid catalytic cracking apparatus of claim 18 further comprising a coolant storage unit coupled to the heat transfer device, wherein the coolant storage unit is configured to store a liquid coolant, and wherein the heat transfer device is configured to return a coolant to the coolant storage unit after the coolant passes through the heat transfer device.

20. A method of catalytically cracking hydrocarbons, the method comprising the steps of:
fluidizing a cracking catalyst in a riser at cracking conditions;
injecting a first feedstock into the riser through a first distributor pipe at a feedstock injection temperature; and
controlling the feedstock injection temperature to within a prescribed temperature range with a coolant, wherein the coolant flows through a temperature control device coupled to the first distributor pipe, and wherein the coolant exits the temperature control device exterior to the riser, and wherein the coolant flows in a counter current manner in the temperature control device.
